(19) United States
(12) Patent Application Publication
(10) Pub. No.: US 2016/0325595 A1
(43) Pub. Date: Nov. 10, 2016

(54) Method For Controlling The Damping Force Of Adjustable Dampers In Motor Vehicles, Particularly In Commercial Vehicles

(71) Applicant: MAN Truck & Bus AG, Munchen (DE)

(72) Inventors: Philipp WAGNER, Munchen (DE); Jan FLEISCHHACKER, Olching (DE); Thomas ILLE, Eichenau (DE)

(21) Appl. No.: 15/148,250

(22) Filed: May 6, 2016

(30) Foreign Application Priority Data
May 8, 2015 (DE) 10 2015 005 964.5

(51) Int. Cl. B60G 17/0165; B62D 33/06; B60G 17/06

(52) U.S. Cl. CPC B60G 17/0165; B60G 17/06; B62D 33/0604; B60G 2400/80; B60G 2400/90; B60G 2400/82; B60G 2400/84; B60G 2500/10; B60G 2600/18; B60G 2800/162; B60Y 2400/86

(57) ABSTRACT

A method and a device for controlling the damping force of adjustable dampers in motor vehicles, particularly in commercial vehicles. The control of the damping force of adjustable dampers is effected in dependence on at least one parameter from which a chassis requirement and/or a road condition can be derived and which is provided by an off-board data source and the current values of which are received by the motor vehicle in driving mode.

### BACKGROUND OF THE INVENTION

1. Field of the Invention

The invention relates to a method for controlling the damping force of adjustable dampers in motor vehicles, particularly in commercial vehicles and to a device.

2. Description of the Related Art

The design of chassis control systems always requires a compromise between comfort and driving safety. An ideal chassis should dampen the vibrations caused by road bumps as well as possible and, at the same time, keep the vertical wheel forces as constantly as possible at a predetermined value because the wheels, as a result, have the highest longitudinal and lateral guidance potential and guide the vehicle with optimal safety.

The damper systems presently existing in vehicles can be divided into three groups: passive, semi-active, and active damper systems. In the case of passive damper systems, the size and the direction of the force exerted by the damper is only dependent on the relative speed of the damper. In passive damper systems, a change in the damping force whilst driving is not provided. The alignment of a vehicle having passive shock absorbers always represents only a compromise since different states of driving must be covered with the same chassis setting.

One solution for this conflict in aims consists in using semi-active shock absorbers that make it possible to change the damper characteristics over a wide range by electronic control and thus to provide an optimum damper adjustment for different driving situations within a few milliseconds. But also for different loading conditions that can produce great differences with respect to total mass and position of the centre of gravity particularly in a commercial vehicle, suitable damper presettings can be selected which are superior to a single alignment of passive dampers.

In the case of semi-active damper systems, their characteristic can be changed rapidly and over a wide range whilst travelling. In particular, such shock absorbers can be based on (proportional) adjusting valves which change the oil flow (Continuous Damping Control), or on magneto- or electro-rheological fluids, wherein a magnetic or electrical field influences the viscosity of the fluid and thus the damping force. Combinations of the technologies are also known from practical applications. In this manner, various control programs can adjust the optimum damping force in dependence on the current driving situation by an adjusting element. In the case of active damper systems, the desired force is provided via an actuator in any direction independently of the relative speed of the damper.

In the prior art, numerous methods for controlling the damping force of adjustable dampers have already been proposed.

A generic method is disclosed in DE 101 26 933 A1, in which the control is effected in dependence on the damper speed and the damper speed signals determined by distance sensors and formation of the difference of the distance sensor signals over a specified time difference.

DE 100 35 150 A1 discloses a vehicle with controllable vibration dampers, the damping characteristics of which are set in dependence on the magnitude of the braking pressure, wherein possibly a feedback control dependent on the vehicle speed is also additionally possible. The damping characteristics can be represented by characteristics that allow either a “hard” setting, that is to say great damping, or a “soft” setting, that is to say little damping. Depending on the braking pressure, an at least short-term setting to a “hard” characteristic is carried out here.

DE 10 2004 053 695 A1 discloses a method for damping body, chassis, or wheel vibrations of a motor vehicle in which a braking state of the motor vehicle is detected via sensors and in which in each case the vertical accelerations and the chassis or wheel accelerations are determined separately via sensors. According to this method, a hard damping characteristic is set for the affected wheels or axles after detection of a braking state and after transgression of a limit value of the vertical acceleration determined via sensors and/or wheel acceleration during a first period of vibration on the body, and retained until a reversal of the wheel load or a reduction in the wheel load below a minimum value is found by the vertical accelerations determined via sensors and/or wheel accelerations. It is only after that that the dampers are controlled within predetermined damper characteristics in the traction and pressure stage.

DE 198 03 370 A1 discloses a method for operating a suspension and damping facility of a motor vehicle in which the dampers of individual wheels are blocked or stiffend in the case of the presence of an acceleration signal lying outside the regular values. This is intended to prevent rebounding of the body.

U.S. Pat. No. 4,741,554 shows a control system for chassis of motor vehicles by which it is intended to prevent too much diving and rebounding of the vehicle (anti-dive and anti-rebound system). In this context, the damping is switched to a harder characteristic in dependence on a height position of the body determined via sensors when braking. This harder characteristic is retained for a particular period. In the unbraked state and above a particular limit height of the body, the damping is switched to “soft”.

EP 0 795 429 A2 discloses a method for controlling a damper that provides a so-called “Skyhook” algorithm during normal travel and is intended to suppress wheel load fluctuations when braking. Depending on the determination of slippage by comparing the wheel revolutions with the actual body speed, depending on the braking pressure—as a starting signal—and depending on the body acceleration, the damping characteristic of individual shock absorbers is here adjusted variably during braking in the traction stage and in the pressure stage substantially in such a manner that in each case only one of the characteristics, that is to say either the traction stage or the pressure stage, is controlled variably whilst the other one in each case is switched to “soft”.

The aforementioned approaches from the prior art have in common that for controlling the damping force of adjustable dampers one or more parameters are determined by sensors in the vehicle from which a chassis requirement and/or a road condition can be derived. Examples of such parameters are, as explained above, a braking state of the motor vehicle, the body acceleration, i.e. the vertical acceleration of the body, the chassis, or wheel accelerations and/or the damper speed. To measure the parameter values, distance sensors can be used, for example, which measure the distance between a wheel and a vehicle body in the course of time.

One disadvantage of the familiar approaches is that they enable the damper setting to be adapted only after an impairment or improvement of the road condition has already occurred, which is disadvantageous from points of view of safety, comfort and wear.

### SUMMARY OF THE INVENTION

It is thus an object of the invention to provide an improved method for controlling the damping force of adjustable dampers in motor vehicles, particularly in commercial vehicles, by which disadvantages of conventional techniques can be avoided. It is an object of the invention, in particular, to provide a method for controlling the damping force of adjustable dampers in motor vehicles which improves the driving safety and comfort for the driver. A further object is to provide a device for controlling the damping force of adjustable dampers in motor vehicles by which disadvantages of conventional devices can be avoided.

According to one aspect of the invention, a method for controlling the damping force of adjustable dampers in motor vehicles, particularly in commercial vehicles, having active and/or semi-active damper systems is proposed. According to general aspects of the invention, the control is effected in dependence on at least one parameter from which a chassis requirement and/or a road condition can be derived, one parameter value of the at least one parameter being provided by an off-board data source and received by the motor vehicle in driving mode.

One special feature of the invention is that the parameter or parameters used for controlling the damping force are not, or at least not exclusively, measured by sensors in the vehicle but are provided by an off-board data source. By such externally provided data, a greater depth of interpretation of the current driving situation and especially also of the environment of the vehicle can be achieved by which requirements for the damper or chassis adjustment can be determined early and predicted.

For example, the off-board data source can be at least one other vehicle, preferably a preceding other vehicle, parameter values of the at least one parameter being received from the at least one other vehicle wirelessly via a vehicle-to-vehicle communication. This offers the advantage that the vehicle can receive relevant data for the damper setting directly, preferably in real time, from preceding other vehicles in order to be informed within a short time about altered demands on the damper setting, e.g. a worsening of the road lying ahead. Thus, the vehicle may be able to adapt its damper setting in time.

Furthermore, the possibility exists within the context of one aspect of the invention that the off-board data source is a database, preferably an Internet database, in which parameter values of the at least one parameter are deposited and can be called up from the motor vehicle by wireless remote query. This offers the advantage that the vehicle can procure information generated off board on the chassis setting by a vehicle-to-vehicle communication independently of the availability of the at least one parameter. Furthermore, according to this variant, it is possible to access the most varied databases or so-called big data data sources that contain data relevant to the damper setting and can be evaluated by the vehicle. Furthermore, the aforementioned data of the other vehicle can be temporarily stored in a database, e.g. in order to also provide for access to it when no vehicle-to-vehicle communication is possible between the vehicles.

For example, the at least one parameter can contain an item of weather information, an item of traffic information, a road condition, and/or an item of map information relating to the current driving position and/or travel route of the vehicle. An item of weather information can specify whether precipitation or a wet road is to be expected at the current driving position and/or where on the travel route ahead it is to be expected. At these places, the controller can set a safety-oriented damper setting. Analogously, a road condition, e.g. “good”, “normal”, “poor”, can specify whether road bumps, potholes etc. are to be expected at the current driving position and/or where on the travel route ahead they are to be expected. In this sense, a chassis requirement and/or a road condition can be derived from these parameters and then used for setting the damping force. According to the aforementioned variant embodiment, a safety-based damper setting that produces the lowest possible wheel load fluctuations can then be set for the damping force of the adjustable damper when, for example, the at least one parameter specifies an item of weather information and this specifies a high probability of rain or snow at the current driving position of the motor vehicle.

A further advantageous possibility of the implementation according to the invention provides that the at least one parameter specifies an operating condition and/or a driving characteristic of at least one other vehicle which is currently driving or has driven on the same road or at least in the vicinity of the motor vehicle. In the case of the reception of the at least one parameter via a vehicle-to-vehicle communication, the other vehicle is preferably another vehicle driving ahead with respect to the vehicle.

One variant of this embodiment provides that the at least one parameter specifies a current speed variation of the other vehicle or a current speed variation can be derived from it. For example, it is possible to infer from a sudden speed reduction of the preceding other vehicle or from an increased braking activity a temporary impairment, soiling of the road condition, or the presence of foreign bodies on the road if it has been determined from other, e.g. Internet-based sources additionally that neither a corresponding speed limitation nor congestion is present. If in this manner a worsening condition road is inferred and a safety-oriented damper setting can be chosen.

Furthermore, it is advantageous if the at least one parameter specifies a damper or chassis activity, particularly a wheel and/or body movement, of the at least one other vehicle or this can be derived from it. For example, the other vehicle can provide the measurement values of its chassis sensors in predetermined standardized form by a vehicle-to-vehicle communication. By this data of the other vehicle, a changed unevenness of the road ahead can be detected immediately, specifically before the vehicle reaches this relevant place.

In a variant of the aforementioned illustrative embodiments, the respective parameter values are provided together with an item of location information, e.g. in the form of GPS data, which specifies the geographic position to which the respective parameter value applies. This provides for an accurate prediction of the position at which the damping force is to be adapted within the context of the controller.

According to a further variant embodiment, the control can be effected in dependence on at least one parameter determined on board so that data determined off board can be combined with data determined on board in order to improve the damper control. The parameter determined on board can be a parameter determined on board as described before in conjunction with the prior art.

It is particularly advantageous, however, if the at least one parameter determined on board is a parameter from which a chassis requirement and/or a road condition can be derived and which is provided by at least one driver assistance system.

For example, the at least one driver assistance system can comprise a proximity control and the parameter determined on board can specify a speed or a speed variation of a preceding other vehicle which is continuously detected by the proximity control.

It is a further possibility in the context of the invention that the at least one driver assistance system comprises a camera system, laser system, and/or radar system of the vehicle and the parameter determined on board specifies a current item of weather information and/or road information determined by such a system from which, in turn, a chassis requirement and/or a road condition can be derived.

According to a further variant embodiment, the received values of the at least one parameter of the off-board data source are validated by the values of the parameter determined on board. This means that the parameters of the off-board data source(s) that are used and the parameters determined on board can contain redundant and/or complementary information in order to improve the accuracy and reliability of the derivation of a chassis requirement and/or a road condition from these data sources. For example, from a sudden speed reduction of a preceding other vehicle which is detected by the proximity control, a hazard braking of the preceding other vehicle due to a worsening of the road condition or foreign bodies (e.g. tyre parts etc.) can be inferred if it has additionally been determined from other off-board, e.g. Internet-based data sources by means of complementary traffic and map information that there is neither a corresponding speed limit nor a traffic jam.

According to a preferred embodiment, the adjustable damper is a semi-active shock absorber of a chassis. However, the invention can be applied not only for controlling semi-active chassis. The controlled damper system can be a driver cabin damper system and/or a load storage system of a commercial vehicle. The so-called Skyhook control predominates here since driver cabin storage does not have a direct influence on the wheel guidance.

According to one aspect of the invention, the vehicle can derive a time-variable information item that can be allocated to a road section, particularly a road condition, an item of traffic information, an item of weather information, e.g. the presence of snow and ice, by an on-board sensor system and/or from traffic signal recognition of own or other vehicles. According to this aspect, the vehicle generates map data on which road sections are marked for which the time-variable information item has been determined, e.g. road sections that exhibit a predetermined, particularly poor road condition, the information item determined being allocated to the marked road sections. According to this aspect, the vehicle transmits the generated map data to another vehicle via vehicle-to-vehicle communication and/or to a database, preferably an Internet database. According to this variant, motor vehicles can provide each other with information which can be used for controlling the dampers.

Within the context of the invention, a device for controlling the damping force of adjustable dampers in motor vehicles, particularly in commercial vehicles, comprising active and/or semi-active damper systems is proposed, the device being configured to perform the controlling in dependence on at least one parameter from which a chassis requirement and/or a road condition can be derived. According to general aspects of the invention, the device is configured to receive parameter values of the at least one parameter from an off-board data source in driving mode. In particular, the device is configured to perform the method as disclosed herein. To avoid repetitions, features disclosed purely in accordance with the method should also apply and be claimable as disclosed according to the device.

Furthermore, the invention relates to a motor vehicle, particularly a commercial vehicle, comprising a device as disclosed herein.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The preferred embodiments and features of the invention previously described can be combined arbitrarily with one another. Further details and advantages of the invention will be described in the text which follows, referring to the attached drawings, in which:

FIG. 1 is a diagrammatic illustration of a vehicle-to-vehicle communication and a remote query of a database according to one embodiment of the invention;

FIG. 2 is a schematic block diagram of a vehicle with a device for controlling the damping force of adjustable dampers according to one embodiment of the invention; and

FIG. 3 is a flowchart for illustrating a method for controlling the damping force of adjustable dampers according to one embodiment of the invention.

### DETAILED DESCRIPTION OF THE PRESENTLY PREFERRED EMBODIMENTS

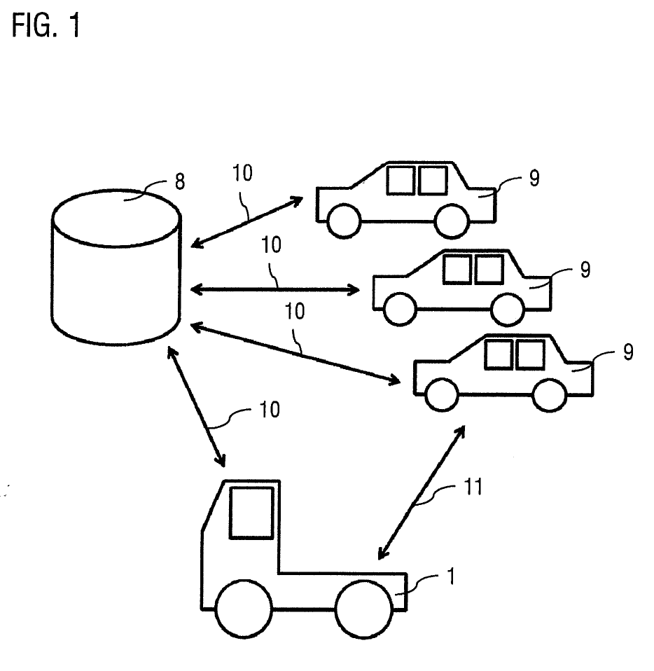

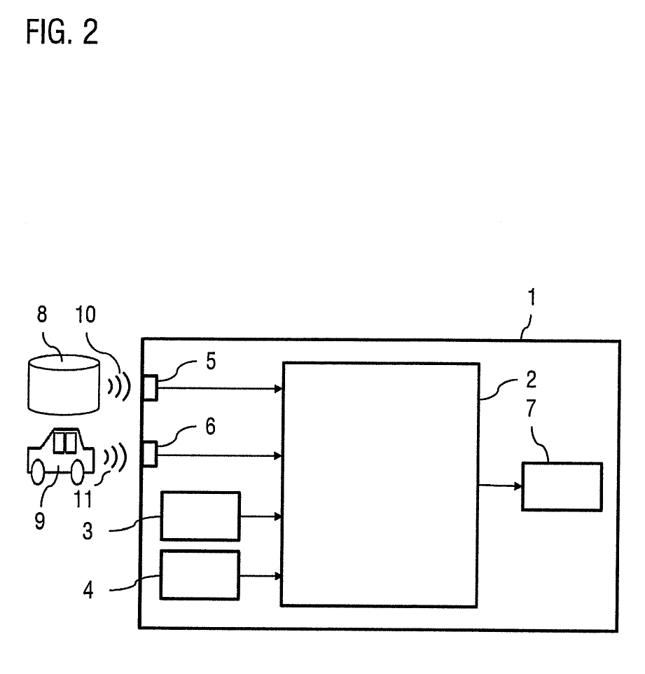

FIG. 1 shows a vehicle-to-vehicle communication 11 and a remote query 10 from a database 8 according to one aspect of the invention. The commercial vehicle comprises a device for controlling the damping force of the semi-active dampers, which will be explained in still greater detail in the text which follows, in conjunction with FIG. 2.

The device for controlling the damping force continuously communicates in driving mode of the commercial vehicle 1 via vehicle-to-vehicle communication 11 with other vehicles 9 which are located within range of the vehicle-to-vehicle communication and which are also equipped with a device, configured according to the invention, for controlling the damping force. The wireless vehicle-to-vehicle communication is shown by the arrow identified by the reference symbol 11. The vehicle-to-vehicle communication here is bidirectional, i.e. a vehicle involved in the vehicle-to-vehicle communication receives parameter values determined by another vehicle 9 from which a chassis requirement and/or a road condition can be derived, and, at the same time, sends corresponding parameter values determined on board to other vehicles 9 via the vehicle-to-vehicle communication interface.

The device 2 of the commercial vehicle 1 also communicates in driving mode with one or more external databases 8 in order to access parameter values deposited there from which a chassis requirement and/or a road condition can be derived, and also transmits parameter values determined especially for temporary storage to one or more external databases 8 so that other vehicles 9 have access to them. Analogously, the other vehicles 9 communicate with the external database 8. The wireless bidirectional communication with one or more external databases 8 is shown by the arrows marked by the reference symbol 10.

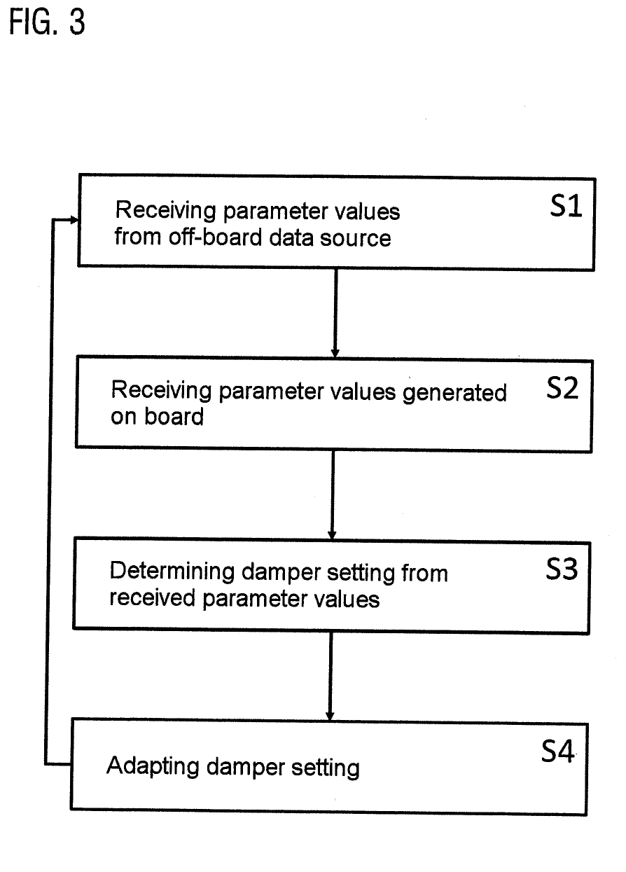

FIG. 2 shows in a rough overview the block diagram of a commercial vehicle 1 equipped with the device 2 for controlling the damping force of adjustable dampers. Device 2 comprises processor and memory. Reference is also made to FIG. 3 which explains the operation of the device 2 and generally the method according to the invention by way of example by means of a flowchart.

The vehicle 1 is equipped with a number of semi-active dampers (shock absorbers) 7, the damping characteristic of which can be adjusted by the device 2. In this context, semi-active dampers 7 are allocated to the wheels of the commercial vehicle 1 and the driver cabin of the commercial vehicle in a manner known. The shock absorbers 7 must be controlled depending on the driving situation and road condition. To determine the damper setting, the device 2 is configured to receive various predetermined parameters or their current values, from which a chassis requirement and/or a road condition can be derived, from different external data sources 8, 9 (step S1) and internal data sources 3, 4 (step S2).

For this purpose, the device 2 continuously communicates, as part of step S1 as already described in conjunction with FIG. 1, via the vehicle-to-vehicle interface 6 of the vehicle 1 with preceding other vehicles 9 if these are correspondingly configured to determine the parameters predetermined for controlling the damper settings and provide them to other vehicles via a vehicle-to-vehicle communication. Furthermore, the device 2 communicates via a wireless interface 5 of the vehicle, as also already described in conjunction with FIG. 1, with one or more external databases 8 in order to access parameter values deposited there from which a chassis requirement and/or a road condition can be derived.

At the same time, the device 2 continuously communicates, as part of step S2, via a CAN data bus with on-board sensors 4 arranged in the area of the adjustable dampers provide the device 2 with current values of one or more parameters from which a chassis requirement and/or a road condition can also be derived. Furthermore, the controller 2 is configured to use at least one parameter which is generated by a driver assistance system 3 of the vehicle 1.

The device 2 is configured, for performing the control procedure of the damper settings as part of a higher-level operating strategy, to acquire the driving situation, the wish of the driver, the road condition and/or vehicle condition by means of the parameter values received from the various data sources 3, 4, 8, and 9 and then, in accordance with predetermined assessment criteria, to set, e.g., a comfort- or safety-oriented damper control (step S3). At a lower level, the vehicle and driver cabin movements and the vibration characteristics of the individual wheels are then controlled, the global control input being specified by the operating strategy in dependence on the respective situation (step S4).

In the text which follows, further aspects of steps S1 to S4 will be explained by illustrating examples.

According to one aspect, the on-board sensors 4 arranged in the region of the adjustable dampers 7, by which sensors the movement of one or more elements influenced directly by the dampers 7, such as wheel and body movements, is detected, can be designed, as has been described initially in conjunction with the prior art, in order to determine, for example, the body acceleration, the chassis or wheel accelerations and/or the damper speed. For example, distance sensors can be provided which measure the distance between a wheel and a vehicle body in the course of time.

Based on the continuously determined parameter values of the on-board sensors 4, the damping characteristic can be adapted in a known manner. From an increased body acceleration, it is possible to infer, for example, increased unevenness or ground waviness of the road since the body acceleration is dependent on the macrostructure of the ground and the vehicle, after its first dip, springs back with different intensity depending on the hardness of the damping set and depending on the severity of the unevenness, i.e. the body is accelerated in the vertical direction and away from the ground. If the measured body acceleration thus exceeds a predetermined threshold value, an uneven road condition and, accordingly, a “softer” setting of the dampers can be derived from this as chassis requirement and the damper characteristic then controlled accordingly within predetermined damper characteristics.

From the measurement values of the on-board sensors 4, a chassis requirement and/or a road condition can thus be derived as described above, but only when the altered chassis requirement and/or a road condition has already occurred, for example in the form of increased unevenness or ground waviness of the road.

According to one aspect of the invention, this known control of the damper settings is thus supplemented and superimposed by a higher-level operating strategy. For this purpose, one or more parameters are additionally used from which a chassis requirement and/or a road condition can also be derived which, however, are provided by an off-board data source 8, 9 and the current values of received by the vehicle 1 in driving mode.

The data received in this respect in step S1 can be, for example, weather information. In the case of rain, snow, etc. a strongly safety-based damper setting having the aim of least wheel load fluctuations is activated on the basis of the findings.

Furthermore, the data can comprise traffic and/or map material information. For example, map data can be deposited in the database 8, in which positions and/or sections with poor roadway surfaces etc. are marked. When such map data are present, these are queried by the device 2 for the current driving route and evaluated so that the device 2 recognizes an impending road impairment before it is reached by the vehicle 1. In this case, the device 2 can adapt the characteristics of the dampers 7 in time before reaching the road impairment before the on-board sensors 4 can detect this road impairment by a vehicle or driver cabin body movement. On the other hand, the vehicle 1 can “mark” route sections via dynamic map data when these are detected by the on-board sensors 4 and thus forward poor road surfaces by the marked map data to other vehicles or the external database 8.

Furthermore, the device 2 can continuously monitor the speed of preceding vehicles which is received from the preceding other vehicles by a vehicle-to-vehicle communication or is obtained directly from a proximity control (speed control system) of the vehicle. The frequently camera-based information of proximity controls or information from sensors such as laser, radar etc. provides for a greater depth of interpretation of the current driving situation and vehicle environment than by the conventional sensors 4 that only detect the movement of the elements influenced directly by the dampers 7, such as wheel and body movements, as a result of which better predictability is achieved. For example, it is possible to infer from a sudden reduction in speed of the preceding other vehicles a possible worsening of the road condition if it is known from other Internet-based sources that there is neither a speed limit nor a traffic jam.

In step S3, the data of the different data sources 3, 4, 8, 9 are thus evaluated and combined. By using the different data sources 3, 4, 8, 9, it is possible to generate additional information due to cross connections between individual information items and to predict changing damper requirements, therefore, more accurately and earlier. If e.g. hazard braking of the preceding other vehicle is detected by means of the variation of travelling speed of the preceding vehicle, the device 2 initiates a chassis setting which favours minimum braking distance, e.g. by a so-called Groundhook control.

A further advantage of using the different data sources 3, 4, 8, 9 is that by complementary and/or redundant information, a chassis requirement and/or a road condition can be derived in a manner less susceptible to errors from the parameter values. Thus, for example, data pulled from an external Internet database 8 relating to the current weather and traffic situation can be harmonized via the camera systems and/or laser/radar sensors of other assistance systems 3 and confirmed. In this context, the higher reliability of information improves the data quality.

The invention is not restricted to the preferred illustrative embodiments described above. Instead, a multiplicity of variants and deviations are possible which also use the concept of the invention and therefore fall within its scope. In particular, the invention also claims protection for the subject matter and features of the subclaims independently of the claims referred to.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for controlling a damping force of an adjustable damper in a motor vehicle, comprising:
receiving, by the motor vehicle in a driving mode, at least one parameter value of a respective at least one parameter provided by an off-board data source;
deriving at least one of a chassis requirement and a road condition from the at least one parameter value of the at least one parameter; and
controlling the damping force of the adjustable damper based at least in part on the at least one parameter.

2. The method according to claim 1, wherein the off-board data source is at least one of
(a) at least one other vehicle and the at least one parameter value of the at least one parameter is received wirelessly via a vehicle-to-vehicle communication; and
(b) a database, in which the at least one parameter value of the at least one parameter is deposited and can be called up from the motor vehicle by a wireless remote query.

3. The method according to claim 1, wherein the at least one parameter is one of an item of weather information, an item of traffic information, a road condition, and an item of map information relating to a current driving position of the motor vehicle.

4. The method according to claim 1, wherein the at least one parameter specifies at least one of an operating condition and a driving characteristic of at least one other vehicle currently driving on at least one of a same road or in a vicinity of the motor vehicle.

5. The method according to claim 4, wherein one or more of a current speed variation, a chassis activity, a wheel movement, and a body movement of the at least one other vehicle can be derived from the at least one parameter.

6. The method according to claim 3, wherein the at least one parameter value is provided with an item of location information that specifies a geographic position to which the respective parameter value applies.

7. The method according to claim 1, wherein the control takes place based at least in part on at least one parameter determined on board of at least one driver assistance system from which at least one of a chassis requirement and a road condition can be derived.

8. The method according to claim 7, wherein the at least one driver assistance system comprises a proximity control and the at least one parameter determined on board specifies one of a speed of a preceding other vehicle and a speed variation of a preceding other vehicle.

9. The method according to claim 7, wherein the at least one driver assistance system comprises at least one of a camera system, a laser system, and a radar system and the at least one parameter determined on board specifies at least one of a current item of weather information and road information determined by the at least one driver assistance system.

10. The method according to one of claim 7, wherein the received at least one parameter value of the at least one parameter of the off-board data source is validated by the at least one parameter value of the at least one parameter determined on board.

11. The method according to claim 1, wherein a safety-based damper setting for the damping force of the adjustable damper is set which produces a lowest possible wheel load fluctuations when at least one of:
(a) the at least one parameter specifies an item of weather information that specifies a high probability of either rain or snow at a current driving position of the motor vehicle; and
(b) a current speed variation or a chassis activity of at least one other vehicle can be derived from the at least one parameter, the at least one other vehicle is currently driving at least one of on the same road and in a vicinity of the motor vehicle, and if at least one of an increased braking activity can be derived from a speed variation and an increased chassis activity of the at least one other vehicle is present.

12. The method according to claim 1, wherein at least one of
(a) the adjustable damper is a semi-active shock absorber of a chassis;
(b) the adjustable damper is arranged in a driver cabin damping system of a commercial vehicle; and
(c) the adjustable damper is arranged in a load storage system of the commercial vehicle.

13. The method as claimed in claim 1, further comprising:
detecting a time-variable information item allocated to a road section comprising at least one of a road condition, an item of weather information, and an item of traffic information by at least one of an on-board sensor system and a traffic signal recognition;
generating map data on which the time-variable information is allocated to a corresponding road sections; and
transmitting the generated map data to at least one of: another vehicle via a vehicle-to-vehicle communication and a database.

14. A device configured to control a damping force of an adjustable damper in a motor vehicle having a semi-active damper system, comprising:
a receiver configured to receive, in a driving mode, at least one parameter value of a respective at least one parameter provided by an off-board data source; and
a processor configured to derive at least one of a chassis requirement and a road condition from the at least one parameter value of the at least one parameter;
wherein control of the damping force of the adjustable damper is based at least in part on the at least one parameter.

15. A motor vehicle, comprising
an adjustable damper; and
a device comprising
a receiver configured to receive, in a driving mode, at least one parameter value of a respective at least one parameter provided by an off-board data source; and
a processor configured to derive at least one of a chassis requirement and a road condition from the at least one parameter value of the at least one parameter;
wherein control of a damping force of the adjustable damper is based at least in part on the at least one parameter.

16. The method for controlling the damping force of the adjustable damper according to claim 1, wherein the motor vehicle is a commercial vehicle having a semi-active damper system.

17. The method for controlling the damping force of the adjustable damper according to claim 2, wherein the database is an Internet database.
